(19) United States
(12) Patent Application Publication
(10) Pub. No.: US 2002/0152064 A1
(43) Pub. Date: Oct. 17, 2002

(54) Method, apparatus, and program for annotating documents to expand terms in a talking browser

(75) Inventors: Rabindranath Dutta, Austin, TX (US); Karthikeyan Ramamoorthy, Austin, TX (US); Richard Scott Schwerdtfeqer, Round Rock, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 09/833,414

(22) Filed: Apr. 12, 2001

(51) Int. Cl. G06F 17/27

(52) U.S. Cl. 704/9

(57) ABSTRACT

A mechanism is provided in a talking browser that uses an external annotation model to annotate a web page. The browser downloads a resource description framework (RDF) file along with the web page. The RDF file may contain a list of acronyms in the document and the talking browser transcodes the document and reads out the expanded form of an acronym. The annotation could also be extended to difficult words or concepts. Once a user is familiar with the acronyms or difficult terms in a document, the annotation may be disabled.

### BACKGROUND OF THE INVENTION

1. Technical Field

The present invention relates to data processing systems and, in particular, to Internet web browsers. Still more particularly, the present invention provides a method, apparatus, and program for annotating documents to expand terms in a talking web browser.

2. Description of Related Art

The worldwide network of computers commonly known as the “Internet” has seen explosive growth in the last several years. Mainly, this growth has been fueled by the introduction and widespread use of so-called “web browsers,” which enable simple graphical user interface-based access to network servers, which support documents formatted as so-called “web pages.” These web pages are versatile and customized by authors. For example, web pages may mix text and graphic images. A web page also may include fonts of varying sizes.

A browser is a program that is executed on a graphical user interface (GUI). The browser allows a user to seamlessly load documents from the Internet and display them by means of the GUI. These documents are commonly formatted using markup language protocols, such as hypertext markup language (HTML). Portions of text and images within a document are delimited by indicators, which affect the format for display. In HTML documents, the indicators are referred to as tags. Tags may include links, also referred to as “hyperlinks,” to other pages. The browser gives some means of viewing the contents of web pages (or nodes) and of navigating from one web page to another in response to selection of the links.

The versatility and customization of web pages, however, are sometimes an impediment to users. Documents that treat complex subjects may include numerous acronyms and difficult terms and concepts. While many acronyms are well known, others may not be so well known. In a typical document, a user may need to keep referring to the first occurrence of an acronym for a definition or expansion until the acronym is committed to memory. For visually impaired users, this poses an additional burden. In addition, talking browsers may be used to read web pages to users who are not visually impaired. For example, a person may use a talking browser to read a web page while the person is driving an automobile. Talking browsers may use search mechanisms to go back to the first occurrence of an acronym or difficult term or concept. However, this may cumbersome and time consuming.

Universal annotation mechanisms provide links for words in web pages. However, since the annotation is universal, links are only provided for common terms. Furthermore, these mechanisms typically either store a single universal list of links locally at the browser. Therefore, if new terms and acronyms are introduced, it may be difficult to update the annotation and apply the update to all web pages universally. Furthermore, this universal annotation is not readily adaptable to talking web browsers, particularly since the annotation is not controlled by the author of the document.

Therefore, it would be advantageous to provide a mechanism to allow the author of a document to annotate documents to expand terms in a talking browser.

### SUMMARY OF THE INVENTION

The present invention provides a mechanism in a talking browser that uses an external annotation model to annotate a web page. The browser downloads a resource description framework (RDF) file along with the web page. The RDF file may contain a list of acronyms in the document and the talking browser transcodes the document and reads out the expanded form of an acronym. The annotation could also be extended to difficult words or concepts. For example, the word “entropy” may be replaced with or followed by a definition of the word. Once a user is familiar with the acronyms or difficult terms in a document, the annotation may be disabled.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a diagram illustrating a talking browser having loaded therein an exemplary document and an associated Resource Description Framework file in accordance with a preferred embodiment of the present invention;

FIG. 5 is a block diagram of an exemplary Resource Description Framework description in accordance with a preferred embodiment of the present invention;

FIG. 6 is a block diagram of a talking browser program in accordance with a preferred embodiment of the present invention; and

FIG. 7 is a flowchart illustrating the operation of a talking web browser in accordance with a preferred embodiment of the present invention.

### DETAILED DESCRIPTION OF THE PREFERRED EMBODIMENT

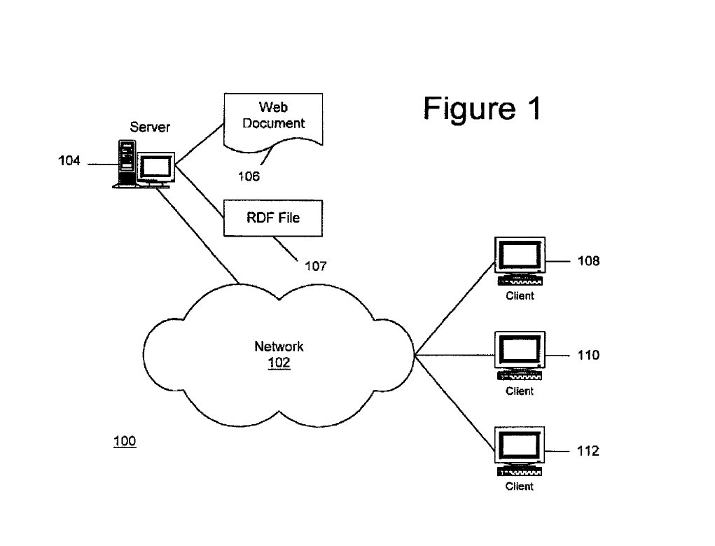

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables. In the depicted example, a server 104 is connected to network 102. In addition, clients 108, 110, and 112 also are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another.

At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

In accordance with a preferred embodiment of the present invention, a talking web browser uses an external annotation model to annotate a web page. The talking web browser may execute on one of clients 108, 110, 112. The browser downloads resource description framework (RDF) file 106 along with the web page 107 from server 104. The RDF file may contain a list of acronyms in the document and the talking browser may transcode the document and read out the expanded form of an acronym. The annotation may also be extended to difficult words or concepts. For example, the word “entropy” may be replaced with or followed by a definition of the word. Once a user is familiar with the acronyms or difficult terms in a document, the annotation may be disabled.

The resource description framework (RDF), developed by the worldwide web consortium (W3C), provides the foundation for metadata interoperability. RDF allows descriptions of any resource with a uniform resource identifier (URI) as its address to be made available in machine understandable form. Resources may be described through a collection of properties called an RDF description. Each property has a property type and value. Values may be atomic in nature (e.g., text strings, numbers) or other resources, which in turn may have their own properties.

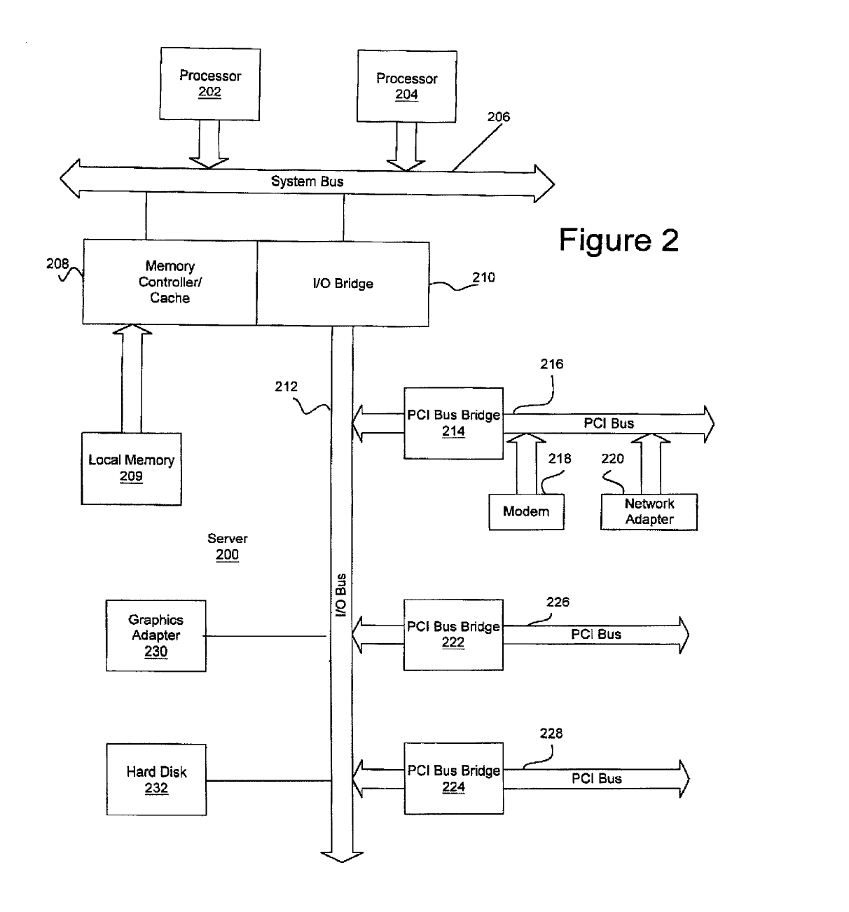

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention. The data processing system depicted in FIG. 2 may be, for example, an IBM RISC/System 6000 system, a product of International Business Machines Corporation in Armonk, N.Y., running the Advanced Interactive Executive (AIX) operating system.

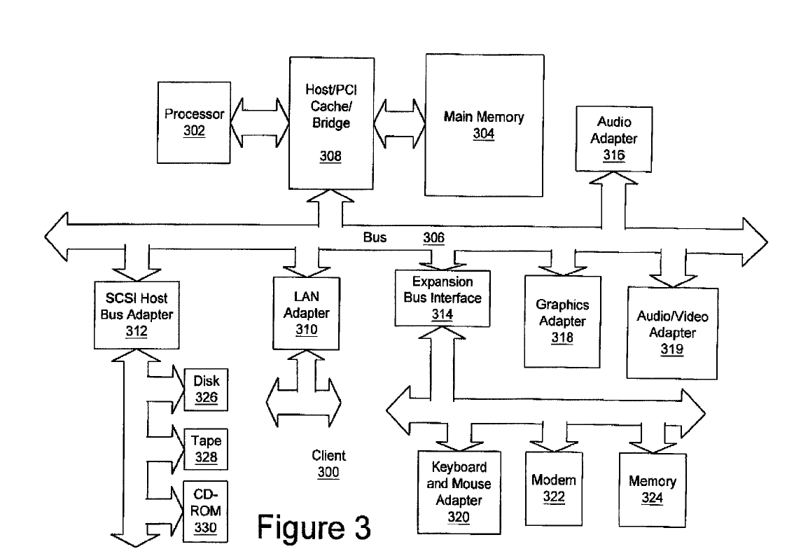

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

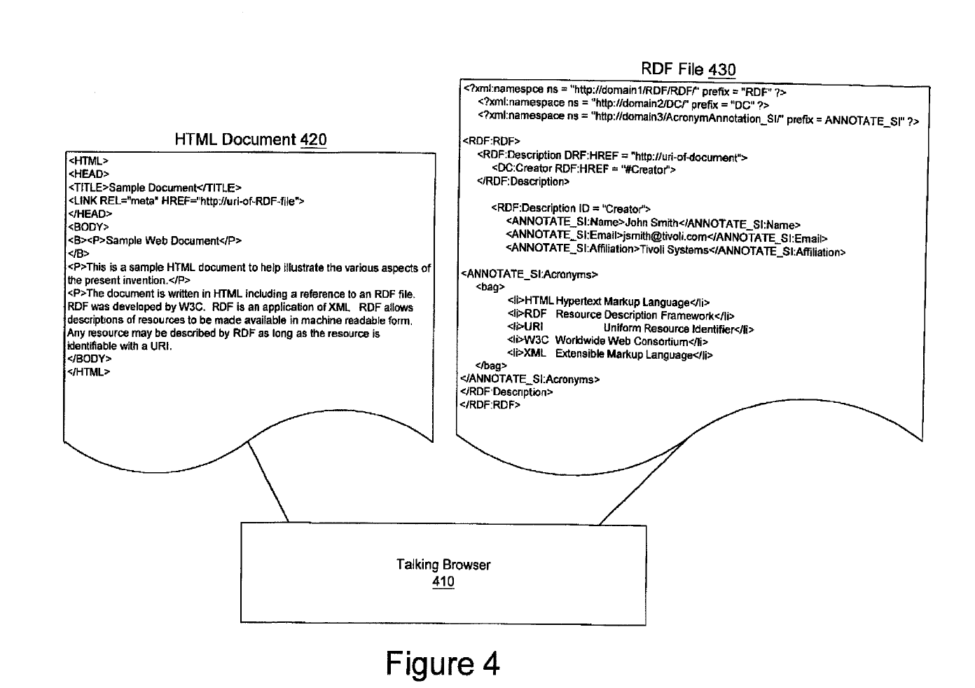

With reference to FIG. 4, a diagram is shown illustrating a talking browser having loaded therein an exemplary document and an associated Resource Description Framework file in accordance with a preferred embodiment of the present invention. Talking browser 410 loads document 420 and associated RDF file 430. Document 420 may be a web document, such as an HTML document. The HTML document may include a tag referencing the RDF file. RDF file 430 includes descriptions for resources associated with document 420. In particular, the RDF description includes a description of a “Creator” resource. The “Creator” resource has properties of “Name,” “Email,” and “Affiliation” that are assigned values in the description.

The description also includes a property of “Acronyms” that is assigned a value. In the example shown in FIG. 4, the acronyms are expressed as a collection with a “bag.” An RDF bag is simply a collection of values for the same property delineated with list (“li”) tags. The acronyms may also be expressed as a single text string, a repeated description of the “Acronyms” property, or a reference to a separate file in which the acronyms are listed. The RDF file may also include a property type for difficult concepts or terms. Alternatively, acronyms and difficult terms may be described in a single property, such as “Expanded_Terms.”

The talking browser may download the RDF file for each page of a multiple page document. Alternatively, as an optimizing solution, the browser may download the RDF file for the whole document when the first page is downloaded. Furthermore, the RDF description may be embedded within document 420.

In the example shown in FIG. 4, document 420 includes occurrences of acronyms, such as “HTML,” “RDF,” “URI,” “W3C,” and “XML.” Talking browser 410 replaces terms and acronyms in document 420 with expansions from associated RDF file 430. For example, a listing of “URI Uniform Resource Identifier” in the RDF file would result of each instance of “URI” in document 420 being replaced with the text “Uniform Resource Identifier.” Thus, the browser may present the web page without the user having to remember or refer back to the definition of a term or acronym.

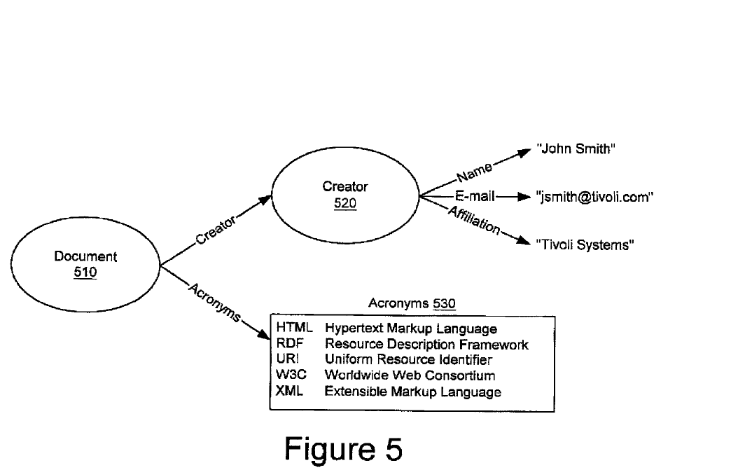

With reference now to FIG. 5, a block diagram of an exemplary Resource Description Framework description is illustrated in accordance with a preferred embodiment of the present invention. An RDF description for document 510 defines property types “Creator” and “Acronyms.” The “Creator” property type has a resource as a value. The resource is creator 520. Creator 520 defines property types “Name,” “Email,” and “Affiliation.” The “Name” property has a value of “John Smith.” The “Email” property has a value of “jsmith@tivoli.com.” And the “Affiliation” property has a value of “Tivoli Systems.”

The “Acronyms” property of document 510 has a value of acronyms 530. Acronyms may be embodied as a string of text, a list or “bag” within the RDF file, or a separate file if the list of terms to be expanded is long. The talking browser may then identify the terms in acronyms 530 and replace the expanded text for the terms in the web page. Document 510 may also include a property type for difficult concepts or terms. Alternatively, acronyms and difficult terms may be described in a single property.

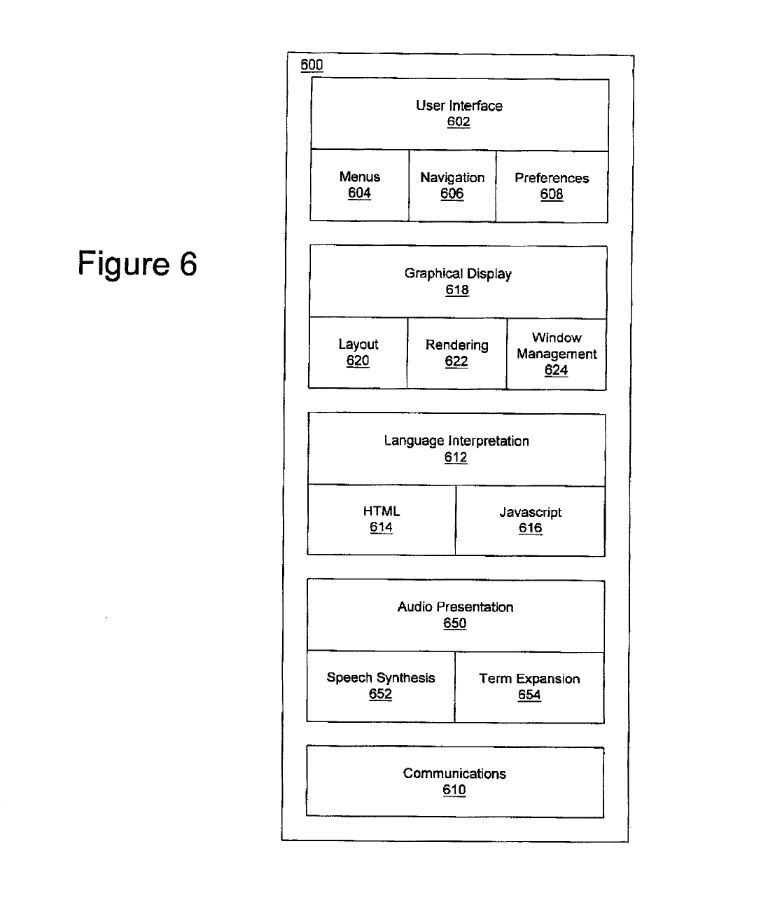

Turning next to FIG. 6, a block diagram of a talking browser program is depicted in accordance with a preferred embodiment of the present invention. A browser is an application used to navigate or view information or data in a distributed database, such as the Internet or the World Wide Web.

In this example, talking browser 600 includes a user interface 602, which is a graphical user interface (GUI) that allows the user to interface or communicate with browser 600. This interface provides for selection of various functions through menus 604 and allows for navigation through navigation 606. For example, menu 604 may allow a user to perform various functions, such as saving a file, opening a new window, displaying a history, and entering a URL. Navigation 606 allows for a user to navigate various pages and to select web sites for viewing. For example, navigation 606 may allow a user to see a previous page or a subsequent page relative to the present page. Preferences may be set through preferences 608.

Communications 610 is the mechanism with which browser 600 receives documents and other resources from a network such as the Internet. Further, communications 610 is used to send or upload documents and resources onto a network. In the depicted example, communication 610 uses HTTP. Other protocols may be used depending on the implementation. Documents that are received by talking browser 600 are processed by language interpretation 612, which includes an HTML unit 614 and a JavaScript unit 616. Language interpretation 612 will process a document for presentation on graphical display 618. In particular, HTML statements are processed by HTML unit 614 for presentation while JavaScript statements are processed by JavaScript unit 616.

Graphical display 618 includes layout unit 620, rendering unit 622, and window management 624. These units are involved in presenting web pages to a user based on results from language interpretation 612. Talking browser 600 also includes audio presentation 650 for “speaking” or “reading” web pages to a user. Audio presentation unit 650 includes speech synthesis unit 652, speech recognition 654, and term expansion unit 656.

Speech synthesis 652 generates machine voice in a known manner. Speech synthesis is typically used to turn text input into spoken words for the visually impaired. Speech recognition 654 converts spoken words into computer text in a known manner. Speech command systems recognize a few hundred words and eliminate using the mouse or keyboard for repetitive commands.

Term expansion unit 656 replaces terms and acronyms in the web page with expansion from an associated RDF file. For example, a listing of “URI Uniform Resource Identifier” in the RDF file would result of each instance of “URI” in the web page being replaced with the text “Uniform Resource Identifier.” Thus, the browser may present the web page without the user having to remember or refer back to the definition of a term or acronym. Once the user is familiar with the acronyms and terms, the user may turn off the transcoding (term expansion) and the talking browser may revert back to reading the original text of the web page. Term expansion 656 may also include a mechanism for turning off transcoding on a term-by-term basis or on a multiple level basis. For example, the RDF file may include flags for terms that indicate whether the term must always be transcoded. Thus, the user may instruct the browser to transcode all terms in described in the RDF file or only those that must always be transcoded. Further, if transcoding is turned off, a user may invoke an expansion of a single term with a command, such as a right-click menu selection or voice command.

Graphical display 618 may also include a mechanism for displaying a cursor that follows the “reading” of the web page. Thus, a user, if able, may control the reading of the web page by manipulation of the cursor. The rendering of the web page may be based only on the original text of the web page or may be based on the transcoded document. Furthermore, the term expansion unit may also be included in graphical display 618. Thus, a web page may be transcoded in a conventional browser for non visually impaired users.

Talking browser 600 is presented as an example of a browser program in which the present invention may be embodied. Talking browser 600 is not meant to imply architectural limitations to the present invention. Presently available browsers may include additional functions not shown or may omit functions shown in talking browser 600. A browser may be any application that is used to search for and display content on a distributed data processing system. Talking browser 600 make be implemented using known browser applications, such Netscape Navigator or Microsoft Internet Explorer. Netscape Navigator is available from Netscape Communications Corporation while Microsoft Internet Explorer is available from Microsoft Corporation.

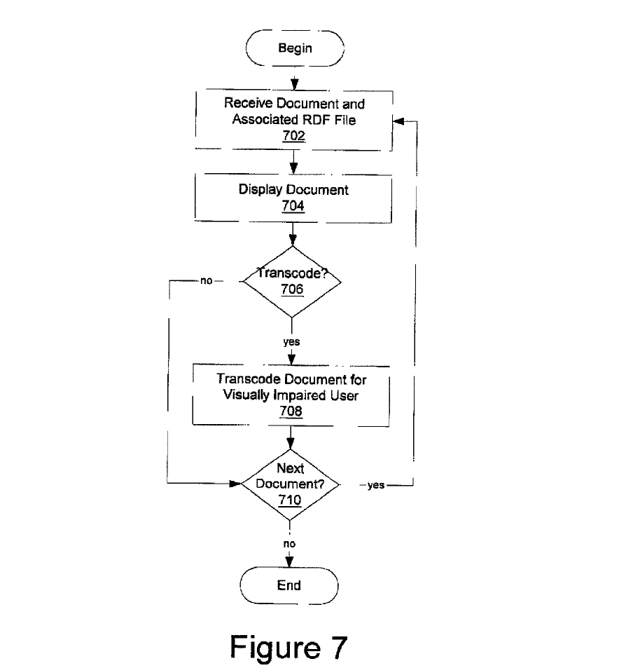

With reference to FIG. 7, a flowchart illustrating the operation of a talking web browser is shown in accordance with a preferred embodiment of the present invention. The process begins, receives a document and associated RDF file (step 702), and displays the document (step 704). A determination is made as to whether to transcode the document (step 706). Step 706 determines whether acronyms need to be expanded. This identification may be made in various ways. For example, the user name and password in a message, an IP address, or a login mechanism may be used to determine whether the user is visually impaired and the page is to be transcoded. The user name and password or IP address may be compared with a list or database. If the page is to be transcoded, the process transcodes the document (step 708) and presents the document.

Next, a determination is made as to whether a next document is selected (step 712). If a next document is selected, the process returns to step 702 to receive the document and an associated RDF file. If a next document is not selected in step 712, a determination is made as to whether an exit condition exists (step 714). An exit condition may comprise the closing of the browser window or termination of the browser program through a voice command.

If an exit condition exists, the process ends. If an exit condition does not exist in step 714, the process returns to step 712 to determine whether a next document is selected. Returning to step 706, if the user does not wish to transcode the document, the process proceeds to step 712 to determine whether a next document is selected.

It is important to note that the transcoding need not always be from acronym to expanded form. Transcoding may also replace a difficult word with a brief explanation or may replace a foreign-language word with a native-language word. Transcoding may also reduce a sequence of words into an acronym as well. Furthermore, while term expansion unit 654 is shown as an integral part of talking browser 600 in FIG. 6, the term expansion unit may also be implemented as a plug-in component. The term expansion unit may also be implemented in a proxy server running on the same machine that the browser is running or on a server machine.

Thus, the present invention solves the disadvantages of the prior art by providing a mechanism in a talking browser that uses an external annotation model to annotate a web page. The browser downloads a resource description framework (RDF) file along with the web page. The RDF file may contain a list of acronyms in the document and the talking browser transcodes the document and reads out the expanded form of an acronym. The annotation could also be extended to difficult words or concepts. For example, the word “entropy” may be replaced with or followed by a definition of the word. Once a user is familiar with the acronyms or difficult terms in a document, the annotation may be disabled. Thus, a user may be presented with a document without having to remember or refer back to a definition of an acronym or difficult term or concept. The present invention also allows the author or creator of a document to dictate which terms will be annotated or expanded.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for expanding terms within a document, comprising:
receiving a document having one or more terms;
receiving an annotation file having one or more term expansions; and
replacing, in the document, a term of the one or more terms with a corresponding term expansion from the annotation file.

2. The method of claim 1, wherein the term comprises an acronym and the corresponding term expansion comprises an expansion of the acronym.

3. The method of claim 1, wherein the term comprises a word and the corresponding term expansion comprises a definition of the word.

4. The method of claim 1, wherein the term comprises a word in a first language and the corresponding term expansion comprises a translation of the word into a second language.

5. The method of claim 1, wherein the term comprises a series of words and the corresponding term expansion comprises an acronym for the series of words.

6. The method of claim 1, wherein the document comprises a hypertext markup language document.

7. The method of claim 1, wherein the annotation file comprises a resource description framework file.

8. The method of claim 7, wherein the resource description framework file describes one or more properties, each property having a value.

9. The method of claim 8, wherein a property of the one or more properties and the value corresponding to the property describe the expansion terms.

10. The method of claim 1, further comprising displaying the document.

11. The method of claim 1, further comprising presenting the document as audible speech.

12. An apparatus for expanding terms within a document, comprising:
a communications interface configured to receive a document having one or more terms and receive an annotation file having one or more term expansions; and
transcoder configured to replace, in the document, a term of the one or more terms with a corresponding term expansion from the annotation file.

13. The apparatus of claim 12, wherein the term comprises an acronym and the corresponding term expansion comprises an expansion of the acronym.

14. The apparatus of claim 12, wherein the term comprises a word and the corresponding term expansion comprises a definition of the word.

15. The apparatus of claim 12, wherein the term comprises a word in a first language and the corresponding term expansion comprises a translation of the word into a second language.

16. The apparatus of claim 12, wherein the term comprises a series of words and the corresponding term expansion comprises an acronym for the series of words.

17. The apparatus of claim 12, wherein the document comprises a hypertext markup language document.

18. The apparatus of claim 12, wherein the annotation file comprises a resource description framework file.

19. The apparatus of claim 18, wherein the resource description framework file describes one or more properties, each property having a value.

20. The apparatus of claim 19, wherein a property of the one or more properties and the value corresponding to the property describe the expansion terms.

21. The apparatus of claim 12, further comprising:
a display device configured to display the document.

22. The apparatus of claim 12, further comprising:
an audio output device configured to present the document as audible speech.

23. A computer program product, in a computer readable medium, for expanding terms within a document, comprising:
instructions for receiving a document having one or more terms;
instructions for receiving an annotation file having one or more term expansions; and
instructions for replacing, in the document, a term of the one or more terms with a corresponding term expansion from the annotation file.
